(19) United States
(12) Patent Application Publication
(10) Pub. No.: US 2013/0173645 A1
(43) Pub. Date: Jul. 4, 2013

(54) ELECTRONIC DEVICE AND METHOD FOR SCHEDULE MANAGEMENT

(71) Applicants: YING-CHUAN YU, Tu-Cheng (TW); YING-XIONG HUANG, Tu-Cheng (TW)

(72) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/427,928

(22) Filed: Mar. 23, 2012

(30) Foreign Application Priority Data
Dec. 30, 2011 (TW) 100149693

(51) Int. Cl. G06F 17/30

(52) U.S. Cl. 707/758; 707/E17.005

(57) ABSTRACT

An electronic device includes a data storage for storing scheduled arrangement, a display, and a processor. The processor detects a first place in the scheduled arrangement of a first date which is a first predetermined number of days later than a current date, taking the name of the first place as a place keyword and a date period starting from the current date to a second date which is a second predetermined number of days after the first date as a date keyword to search for information related to the place keyword and the date keyword in a server if the first place related to the first date is detected in the schedule arrangement. The processor displays information returned by the search for the place keyword and the date keyword in the display.

### BACKGROUND

1. Technical Field

The present disclosure relates to an electronic device and method for schedule management.

2. Description of Related Art

Before travelling or going on a business trip to another place, people often search information of the destination, such as weather, information as to local celebrations and holidays, customs, and cultures, to prepare the clothes and others things needed. When searching for the information, people may visit different web sites to search for different information, and are required to manually input the keywords, such as place and date, in the process is usually inconvenient and time wasting.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device 1 with a schedule management function in accordance with an exemplary embodiment.

FIG. 2 is a flowchart of a method for managing a schedule in the electronic device of FIG. 1.

### DETAILED DESCRIPTION

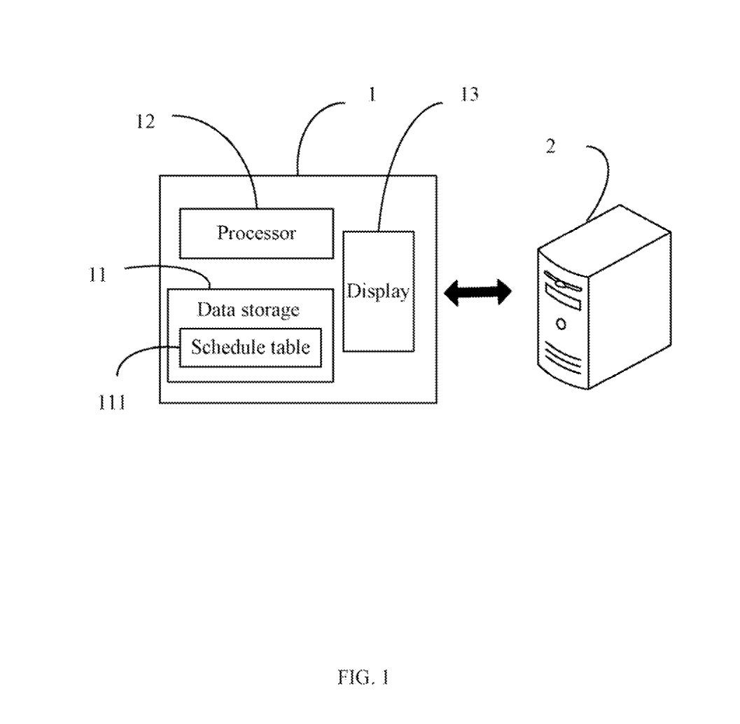

FIG. 1 is a block diagram of an electronic device 1 with a schedule management function in accordance with an exemplary embodiment. The electronic device 1 is capable of connecting to the server 2 to search for information related to a particular date and/or a particular place, such as forecast weather of the place, clothes wearing suggestions, and information as to local celebrations and holidays of the place. The electronic device 1 includes a data storage 11, a processor 12, and a display 13. The data storage 11 stores a schedule table 111 for storing scheduled arrangements of user. The schedule table 111, as shown below, includes dates and scheduled arrangements of each date.

| Date | Schedule arrangement |
|---|---|
| 2011-12-20 | N/A |
| 2011-12-21 | Travel to Shanghai |
| 2011-12-22 | N/A |
| 2011-12-23 | Go to Beijing to see customer |
| 2011-12-24 | N/A |
| . . . | . . . |

The processor 12 detects information as to a place to be visited (first place) in the schedule arrangement, scheduled to take place on a date (first date) which is a first predetermined number of days later than the current date (that is to say, today). In the embodiment, the first date is deemed to endure for only one day, and thus one day is the period searched by the processor 12. The predetermined number of days between the current date and the first date can be set by the user. For example, if the number of predetermined days is three and the current date is 2011 Dec. 17, the processor 12 detects information concerning the first place as at 2011 Dec. 20 which is the first date in this example.

If the processor 12 does not detect information concerning a first place in the scheduled arrangements relating to or associated with a first date, the processor 12 goes further into the future to detect information as to any first place in the scheduled arrangements. If the processor 12 detects information in the scheduled arrangements as to a first place on a first date, the processor 12 goes on to detect information as to any second place for a date between a first date and a second date which is a second predetermined number of days later than the first date. The number of days in the second predetermined number of days can also set by the user. In the embodiment, the second predetermined number of days is three. For example, if attempting to detect information as to the first place “shanghai”, in the scheduled arrangements, for a first date of 2011 Dec. 21, the processor 12 goes on to detect any information as to a second place in the scheduled arrangements of any dates between 2011 Dec. 21 and 2011 Dec. 24.

If the processor 12 does detect information as to a second place in the scheduled arrangements between the first date and the second date, the corresponding date of the scheduled arrangement in which the second place information is detected is taken as a third date, and the processor 12 takes the name of the first place as a place keyword and the dates between the current date and the third date as the date keyword to search related information about the place keyword and the date keyword in the server 2. For example, the name “Beijing” is detected as a second place, and 2011 Dec. 23 is established as being the third date, between the first date 2011 Dec. 21 and the second date 2011 Dec. 24, and the processor 12 takes “Shanghai” as the place keyword and the dates between the current date of 2011 Dec. 18 and the third date of 2011 Dec. 23 as the date(s) keyword to search the related information of the place “Shanghai” and dates between 2011 Dec. 18 and 2011 Dec. 23.

If the processor 12 does not detect any second place in the scheduled arrangements for the dates between the first date and the second date, the processor 12 takes the first place as the place keyword and the dates between the current date and the second date as the date keyword to search for related information in the server 2.

The processor 12 displays the related information relative to the place keyword and the date keyword to the display 13 according to a format defined by the user.

In another embodiment, the electronic device 1 stores the date and the place information and any related information which has already been found, and the processor 12 searches for related information based on the place keyword and the date keyword in the electronic device 1.

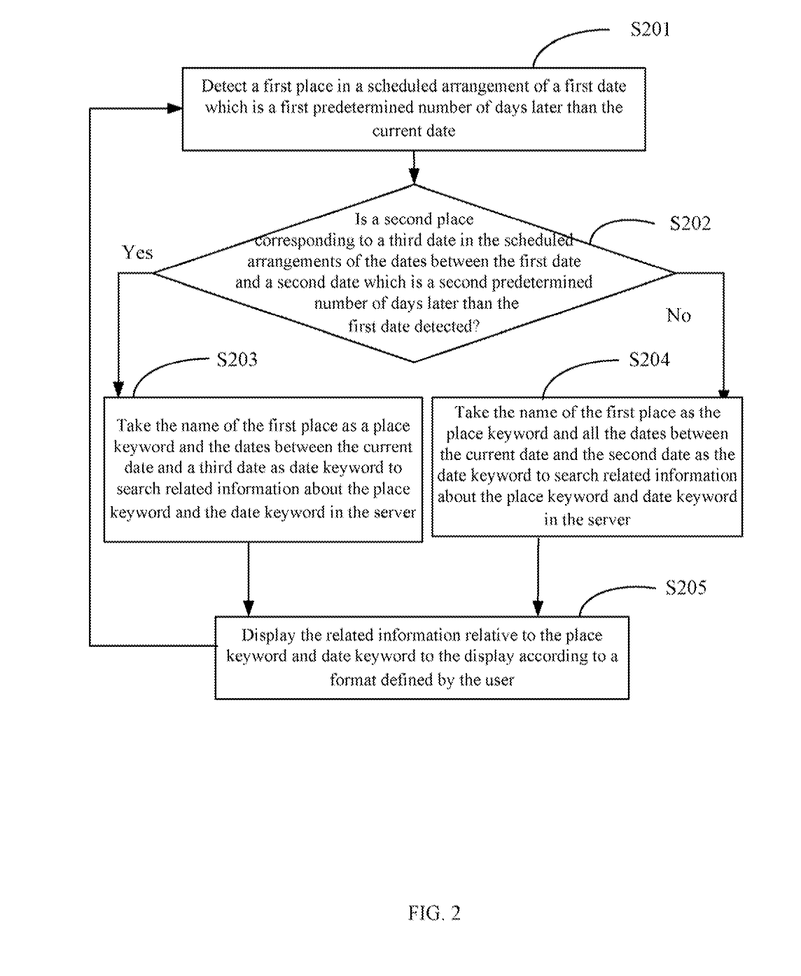

FIG. 2 is a flowchart of a method for managing schedules in the electronic device of FIG. 1.

In step S201, the processor 12 detects a first place in the scheduled arrangement of a first date which is a first predetermined number of days later than the current date.

If the processor 12 detects a first place in the scheduled arrangement of the first date, in step S202, the processor 12 further detects a second place in the scheduled arrangements of the dates between the first date and a second date which is a second predetermined number of days later than the first date.

If the processor 12 detects the second place in the scheduled arrangements between the first date and the second date, the corresponding date of the scheduled arrangement in which the second place information is detected is taken as a third date, in step S203, the processor 12 takes the name of the first place as a place keyword and the dates between the current date and a third date as date keyword to search related information about the place keyword and the date keyword in the server 2.

If the processor 12 does not detect any second place in the scheduled arrangements for any of the dates between the first date and the second date, in step S204, the processor 12 takes the name of the first place as the place keyword and all the dates between the current date and the second date as the date keyword to search related information relative to the place keyword and date keyword in the server 2.

In step S205, the processor 12 displays the related information relative to the place keyword and date keyword on the display 13 according to a format defined by the user.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
a data storage for storing a scheduled arrangement;
a display; and
a processor for detecting a first place in the scheduled arrangement of a first date which is a first predetermined number of days later than a current date, taking the name of the first place as a place keyword and a date period starting from the current date to a second date which is a second predetermined number of days after the first date as a date keyword to search for information related to the place keyword and the date keyword in a server if the first place related to the first date is detected in the schedule arrangement and there is not a second place existing in the scheduled arrangement between the first date and the second date, and displaying information returned by the search for the place keyword and the date keyword in the display.

2. The electronic device as described in claim 1, wherein the processor further detects the second place existed in the scheduled arrangement and dated between the first date and the second date, when the second place is detected, the processor then takes date period between the current date and a third date which corresponds to the second place as the date keyword.

3. The electronic device as described in claim 1, wherein the related information about the place keyword and the date keyword are displayed according to a format defined by the user.

4. A schedule managing method applied to an electronic device, comprising:
storing scheduled arrangement;
detecting a first place in the scheduled arrangement of a first date which is a first predetermined number of days later than a current date;
taking the name of the first place as a place keyword and a date period starting from the current date to a second date which is a second predetermined number of days after the first date as a date keyword to search for information related to the place keyword and the date keyword in a server if the first place related to the first date is detected in the schedule arrangement and there is not a second place existing in the scheduled arrangement between the first date and the second date; and
displaying information returned by the search for the place keyword and the date keyword in the display.

5. The method as described in claim 4, further comprising:
detecting the second place existed in the scheduled arrangement and dated between the first date and the second date;
taking date period between the current date and a third date which corresponds to the second place as the date keyword when the second place is detected.

6. The method as described in claim 4, wherein the related information about the place keyword and the date keyword are displayed according to a format defined by the user.

7. An electronic device comprising:
a data storage for storing scheduled arrangement and related information about dates and places;
a display; and
a processor for detecting a first place in the scheduled arrangement of a first date which is a first predetermined number of days later than a current date, taking the name of the first place as a place keyword and a date period starting from the current date to a second date which is a second predetermined number of days after the first date as a date keyword to search for information related to the place keyword and the date keyword in a in the data storage if the first place related to the first date is detected in the schedule arrangement and there is not a second place existing in the scheduled arrangement between the first date and the second date, and displaying information returned by the search for the place keyword and the date keyword in the display.

8. The electronic device as described in claim 7, wherein the processor further detects the second place existed in the scheduled arrangement and dated between the first date and the second date, when the second place is detected, the processor then takes date period between the current date and a third date which corresponds to the second place as the date keyword.

9. The electronic device as described in claim 7, wherein the related information about the place keyword and the date keyword are displayed according to a format defined by the user.
